(19) United States
(12) Patent Application Publication
(10) Pub. No.: US 2018/0128327 A1
(43) Pub. Date: May 10, 2018

(54) CLAMPING ROLLER FREEWHEEL CLUTCH COMPRISING SPECIAL CLAMPING RAMPS

(71) Applicant: SCHAEFFLER TECHNOLOGIES AG & CO. KG, Herzogenaurach (DE)

(72) Inventor: Alexander REIMCHEN, Herzogenaurach (DE)

(73) Assignee: SCHAEFFLER TECHNOLOGIES AG & CO. KG, Herzogenaurach (DE)

(21) Appl. No.: 15/573,171

(22) PCT Filed: May 4, 2016
(86) PCT No.: PCT/DE2016/200213

§ 371 Date: Nov. 10, 2017

(30) Foreign Application Priority Data
Jun. 2, 2015 (DE) 10 2015 210 108.8

(51) Int. Cl. F16D 41/067

(52) U.S. Cl. CPC F16D 41/067

(57) ABSTRACT

A clamping freewheel clutch comprising an outer ring and two or more clamping ramps being formed along an inner wall of the outer ring, wherein the plurality of clamping ramps correspond to a plurality of clamping rollers and are arranged at a distance from one another, wherein a first clamping ramp includes a clamping angle less than that of an adjacent second clamping ramp. The clamping freewheel clutch further includes one or more springs associated with the two or more clamping rollers and supported on a cage assembly, the spring configured to produce a clamping between the outer ring and an inner section surrounded coaxially thereby.

### CROSS-REFERENCE TO RELATED APPLICATIONS

This application is the U.S. National Phase of PCT/DE2016/200213 filed May 4, 2016, which claims priority to DE 102015210108.8 filed Jun. 2, 2015, the entire disclosures of which are incorporated by reference herein.

### TECHNICAL FIELD

The disclosure relates to a clamping roller freewheel clutch comprising an outer ring, a plurality of clamping ramps being formed along the inner wall of said outer ring, which ramps are arranged at a distance from one another and are each for a corresponding clamping roller, each clamping roller being acted upon by a spring associated therewith and supported on a cage assembly lying between in order to produce a clamping between the outer ring and an inner section surrounded coaxially thereby, said clamping being in a load rotational direction. Further the disclosure also relates to a starter arrangement of a motor vehicle operated in start-stop mode with such a clamping roller freewheel clutch.

The application of the disclosure primarily extends to motor vehicles whose internal combustion engine is started by an electromotive starter. This usually occurs through an interconnected flexible drive which transfers the drive torque of the starter to the crankshaft of the internal combustion engine. A clamping roller freewheel clutch is usually flange mounted on one side to the crankshaft. According to another embodiment a starter can also directly in a ring gear of a clamping roller freewheel clutch so that in this case the flexible drive can be omitted.

In addition, it is also conceivable to also use the disclosed clamping roller freewheel clutch as a self-shifting clutch for return stops, shift elements or overrunning clutches in other machines.

### BACKGROUND

A generic clamping roller freewheel clutch results from DE 10 2013 206 811 A1. This clutch consists essentially of an outer ring as well as a cage arranged next to it, wherein the outer ring is provided with clamping ramps on the inside and clamping rollers are placed in the cage and spring elements allocated to them are fastened on the cage, said spring elements impacting the clamping rollers so that they spring against the clamping ramps, in order to transfer a load torque from the clamping rollers to the outer ring in a load rotational direction. In an opposite freewheel rotational direction a freewheel function is realized without clamping. In the case of this prior art the clamping ramps are manufactured specially from a steel strip whose two ends are bonded to one another. All clamping ramps have the same clamping angle.

Another freewheel clutch results from DE 10 2010 033 503 A1, which is used within the scope of a starter assembly for producing a coupling to a starter ring gear. In the case of this prior art, the pinion of an electromotive starter engages directly in the starter ring gear so that in this case a flexible drive can be omitted. In particular in the case of hybrid applications with start-stop mode a frequent engagement of the starter as a consequence of the shutting off/disconnection of the internal combustion engine at traffic lights with a subsequent renewed starting of the internal combustion engine can be unpleasant/uncomfortable/inconvenient. The freewheel clutch disclosed here ensures that the starter can always remain engaged; crankshaft and starter ring gear are decoupled/uncoupled from one another in the operation of the motor vehicle. In the case of this technical solution clamping bodies of the freewheel clutch are held in axial direction from cage parts arranged on both sides. Contrary to the aforementioned prior art, the clutch effect also does not occur in radial direction but rather in axial direction. This design principle requires relatively a great deal of installation space.

On the other hand, if a generic clamping roller freewheel clutch is used in the case of motor vehicles with start-stop mode, they tend to slip in the case of low temperatures of approximately below −20° Celsius, which can lead to failures/breakdowns in the engine control unit of modern motor vehicles or in the worst case, can destroy the clamping roller freewheel clutch.

Studies have shown that the problem of slipping occurs regardless of the lubricant with which the freewheel clutch is lubricated, in particular oil or grease. This is explained by the fact that the lubricant forms a particularly tough lubricant film in the case of low temperatures which wets the clamping rolls and the corresponding clamping tracks on the inner section as well as the outer ring. In the case of the slightest shocks, which happen in particular in the case of starting the internal combustion engine, the clamping roller loses metallic contact to at least one of the clamping tracks and the freewheel clutch slips. The slipping lasts until at least one of the several clamping rollers regains metallic contact to the two clamping tracks. The freewheel geometry can be damaged or even destroyed by this uneven load.

Attempts have already been made to increase the elasticity to prevent the slipping. To this end the clamping roller should be able to penetrate the lubricant film more easily. However, simultaneously the risk increases that the freewheel clutch generates too much frictional heat and wear and tear in the idle states.

Further reducing the clamping angle of all clamping ramps also does not lead to success, because most freewheel clutches are loaded to the torque capacity limit, so that this is no longer possible. In the case of a lower clamping angle the contact pressure rises.

### SUMMARY

The present disclosure addresses the problem of improving a generic freewheel clutch to the extent that in the case of low temperatures, a slipping is effectively prevented using simple technical means.

The problem may be solved based on the disclosure a clamping roller freewheel clutch in conjunction with its features described herein.

The disclosure describes that at least one of the plurality of clamping ramps of the outer ring is configured as a flatter clamping ramp having a clamping angle α₁ which is less than the clamping angle α₂ of the remaining comparatively steeper clamping ramps.

The advantage of such an embodiment lies in particular in the fact that in the case of starting the flatter clamping ramps grip significantly better than the remaining comparatively steeper clamping ramps. As a result, a slipping of the clamping roller freewheel clutch is prevented.

It is sufficient if fewer than half of the plurality of clamping ramps are configured as flatter clamping ramps, in order to prevent the initial risk of slipping in the case of a cold start of the internal combustion engine.

In the case of several flatter clamping ramps, they should be arranged symmetrically distributed along the outer ring. Thus in the case of two flatter clamping ramps, they should be arranged opposite one another and for example three flatter clamping ramps should be distributed equidistant from one another over the circumference of the outer ring in the shape of a star. As a result, a mutual supporting effect is achieved, which leads to a higher stability of the clamping roller freewheel clutch.

According to one embodiment, which may be suitable in particular for use within the scope of a starter assembly of a motor vehicle operated in start-stop mode, provision is made that the flatter clamping angle α₁ is smaller by 60% with a tolerance of +/−10% than the steeper clamping angle α₂. This relative angular difference is sufficient to achieve the foregoing described advantages of the disclosure. In the case of this application the flatter clamping ramps have a clamping angle α₁ of 1.5 to 2.5° and the comparatively steeper clamping ramps have a clamping angle α₂ of 3 to 4°. Depending on the application these value ranges can however also vary. Studies have shown however that for the aforementioned special application these value ranges for clamping angles α₁ and α₂ secure a reliable function of the clamping roller freewheel clutch even in the case of cold starts at −30° Celsius and a high starter torque for the internal combustion engines of modern motor vehicles.

In order to prevent an overrolling of the flatter clamping ramps by the clamping rollers, the disclosure may include a sharply increasing end region that has a clamping angle of greater than 5°, quite preferably greater than 9°.

The clamping roller freewheel clutch is suitable within the framework of a starter assembly of a motor vehicle operated in start-stop mode both for starters which flexible drive on the flange mounted on a crankshaft act on as well as for starter assemblies in which case the clamping roller freewheel clutch has a ring gear which directly cooperates with a pinion gear of the starter—without a flexible drive lying between.

### BRIEF DESCRIPTION OF THE DRAWINGS

Further measures improving the disclosure will be described in greater detail in the following together with the description of preferred exemplary embodiments of the disclosure on the basis of the figures. The figures show the following:

FIG. 1 shows a schematic lateral view of a starter assembly of a motor vehicle with a flexible drive,

FIG. 2 shows a schematic longitudinal section in the region of the clamping roller freewheel clutch according to FIG. 1,

FIG. 3 shows a schematic longitudinal section through a starter assembly with ring gear on the clamping roller freewheel clutch according to an alternative exemplary embodiment,

FIG. 4 shows a schematic cross-section through a clamping roller freewheel clutch with special clamping ramps, and

FIG. 5 shows a detailed lateral view on the outer ring of the clamping roller freewheel clutch according to FIG. 4 with the different clamping ramps.

### DETAILED DESCRIPTION

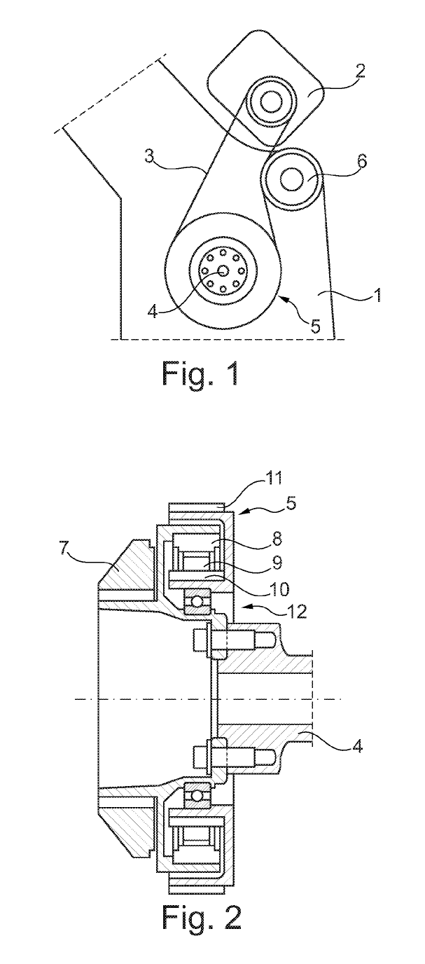

According to FIG. 1 a starter assembly of a motor vehicle operated in start-stop mode—not shown—consists of a starter 2 arranged in the region of an internal combustion engine 1 whose drive torque is transferred via a flexible drive 3 in the form of a toothed belt to the crankshaft 4 of the internal combustion engine 1. A clamping roller freewheel clutch 5 is mounted coaxially on the end side of the crankshaft 4, which with respect to the starter 2 ensures a freewheel if the crankshaft 4 of the internal combustion engine 1 is at least in idling speed after a completed start. The flexible drive 3 is acted upon by a tensioning unit 6.

According to FIG. 2 a flywheel mass 7 is flange mounted on the front side of the crankshaft 4. Said flywheel mass is coupled to an outer ring 8 of the clamping roller freewheel clutch 5. By using the clamping rollers 9 a freewheel clutch connection to an inside 10 of the clamping roller freewheel clutch 5 is produced, which is connected via a ring gear 11 to the output providing flexible drive not further shown. The pivot bearing of the ring gear 11 with the clamping roller freewheel clutch 5 vis-à-vis the crankshaft 4 occurs by a roller bearing 12 arranged in between.

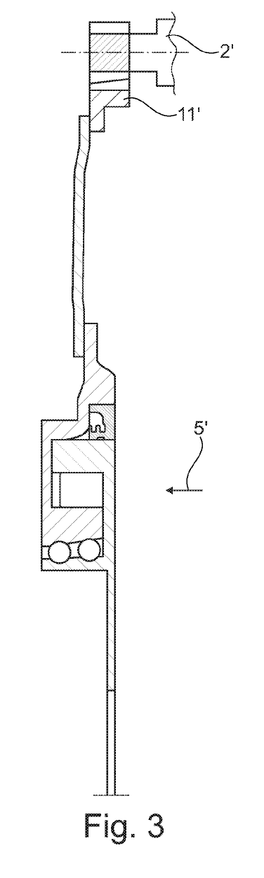

FIG. 3 illustrates another exemplary embodiment, in which case, in contrast to the foregoing described exemplary embodiment the ring gear 11′ of the clamping roller freewheel clutch 5′ may be directly driven by a pinion of a starter 2′—thus without a flexible drive.

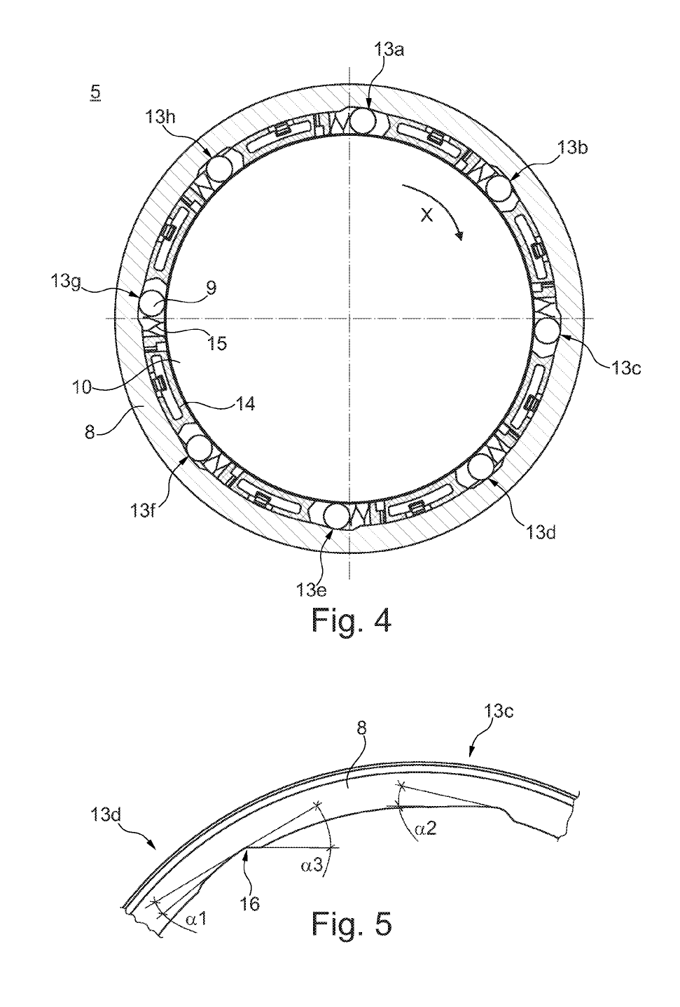

According to FIG. 4 the clamping roller freewheel clutch 5 includes an outer ring 8, a total of eight clamping ramps 13a through 13h configured along the inner wall of said outer ring, said ramps arranged at a distance from one another. Each of the clamping ramps 13a through 13h cooperates with a clamping roller 9 (by way of example) which is positioned as well as acted upon by a spring 15 supported on the associated cage assembly 14.

The two clamping ramps 13d and 13h arranged opposite one another have a flatter clamping angle than the remaining six clamping ramps 13a through 13c as well as 13e through 13g.

FIG. 5 illustrates the clamping ramp geometry of the adjacent clamping ramps 13c and 13d, however mirror inverted. The flat clamping ramp 13d has a clamping angle α₁ of approximately 2°, whereas the exemplary steeper clamping ramp 13c has a clamping angle α₂ of approximately 4°. Due to the schematic representation in the drawing the textual information regarding the clamping angle is applicable. In particular, the exemplary flatter clamping ramp 13d opens into a sharply increasing end region 16, which has a clamping angle α₃ of approximately 10°.

The disclosure is not restricted to the foregoing described exemplary embodiments. Instead, variations thereof are also conceivable, which are included in the protective scope of the following claims. For example, it is also possible that the clamping roller freewheel is also used in the case of other applications as a starter assembly in the case of an internal combustion engine, in order in particular in the case of high temperature differences to obtain a reliable clutch effect.

### REFERENCE LIST

1 Internal combustion engine
2 Starter
3 Flexible drive
4 Crankshaft
5 Clamping roller freewheel clutch
6 Tensioner
7 Flywheel mass
8 Outer ring
9 Clamping roller
10 Inner section
11 Ring gear
12 Roller bearing
13 Clamping ramp
14 Cage assembly
15 Spring
16 End region

1. A clamping roller freewheel clutch comprising:
an outer ring;
a plurality of clamping ramps formed along an inner wall of said outer ring, wherein the ramps are arranged at a distance from one another and each correspond to a plurality of clamping rollers, each clamping roller configured to act upon a spring associated therewith and supported on a cage assembly lying between in order to produce a clamping between the outer ring and an inner section surrounded coaxially thereby, wherein the clamping is in a load rotational direction,
wherein at least one of the plurality of clamping ramps is configured as a flatter clamping ramp with a clamping angle which is less than a clamping angle of remaining comparatively steeper clamping ramps.

2. The clamping roller freewheel clutch of claim 1, wherein fewer than half of the plurality of clamping ramps are configured as flatter clamping ramps.

3. The clamping roller freewheel clutch of claim 2, wherein two or more flatter clamping ramps are arranged symmetrically distributed along the outer ring.

4. The clamping roller freewheel clutch of claim 3, wherein two flatter clamping ramps on the outer ring are arranged opposite one another.

5. The clamping roller freewheel clutch of claim 1, wherein the flatter clamping angle is smaller than the clamping angle by 60% with a tolerance of +/−10%.

6. The clamping roller freewheel clutch of claim 5, wherein the flatter clamping ramps are provided with a clamping angle between 1.5 and 2.5° and the comparatively steeper clamping ramps are provided with a clamping angle between 3 and 4°.

7. The clamping roller freewheel clutch of claim 1, wherein the flatter clamping ramps open into a sharply increasing end region that includes a clamping angle that is greater than 5°.

8. (canceled)

9. The clamping roller freewheel clutch of claim 1, wherein the clamping roller freewheel clutch is configured to be mounted coaxially on an end side of ae crankshaft and is driven by a starter via a flexible drive.

10. The clamping roller freewheel clutch of claim 9, wherein the clamping roller freewheel clutch is configured to be driven by the starter via a ring gear fastened on either the outer ring, directly on the inner section, or via the flexible drive.

11. An apparatus comprising:
an outer ring;
a plurality of clamping ramps being formed along an inner wall of the outer ring, wherein the plurality of clamping ramps correspond to a plurality of clamping rollers and are arranged at a distance from one another; and
a plurality of springs associated with the plurality of clamping rollers and supported on a cage assembly to produce a clamping between the outer ring and an inner section surrounded coaxially thereby.

12. The apparatus of claim 11, wherein at least one of the plurality of clamping ramps includes a clamping angle which is less than that of the remaining clamping ramps.

13. The apparatus of claim 11, wherein the plurality of clamping ramps includes three clamping ramps.

14. The apparatus of claim 13, wherein the distance is equidistant from one another over a circumference of the outer ring.

15. The apparatus of claim 11, wherein the apparatus is in a starter assembly of a motor vehicle configured to operate in a start-stop mode.

16. The apparatus of claim 11, wherein at least one of the clamping ramps opens into an end region with a clamping angle greater than that of a clamping angle of the clamping ramps.

17. The apparatus of claim 16, wherein the clamping angle of the end region is greater than 5°.

18. The apparatus of claim 16, wherein the clamping angle of the end region is greater than 9°.

19. A clamping freewheel clutch comprising:
an outer ring;
two or more clamping ramps being formed along an inner wall of the outer ring, wherein the plurality of clamping ramps correspond to a plurality of clamping rollers and are arranged at a distance from one another, wherein a first clamping ramp includes a clamping angle less than that of an adjacent second clamping ramp; and
one or more springs associated with the two or more clamping rollers and supported on a cage assembly, the spring configured to produce a clamping between the outer ring and an inner section surrounded coaxially thereby.

20. The clamping freewheel clutch of claim 19, wherein two clamping ramps located opposite one another have a flatter clamping angle than that of the remaining two or more clamping ramps.

21. The clamping freewheel clutch of claim 19, wherein the clamping angle of the first clamping ramp is less than that of the remaining clamping ramps.
